(19) United States
(12) Patent Application Publication
(10) Pub. No.: US 2024/0075561 A1
(43) Pub. Date: Mar. 7, 2024

(54) PIPE PROCESSING MACHINE WITH AUXILIARY SUPPORT AND SORTING STRUCTURE

(71) Applicant: CHIAO SHENG MACHINERY CO., LTD., Tainan (TW)

(72) Inventor: SHENG TSUNG WANG, TAINAN (TW)

(21) Appl. No.: 17/903,912

(22) Filed: Sep. 6, 2022

(51) Int. Cl. B23K 37/053; B23K 26/38

(52) U.S. Cl. CPC B23K 37/0533; B23K 26/38

(57) ABSTRACT

The present invention relates to a pipe processing machine with auxiliary support and sorting structure, which is equipped with a first and second slide rails at the front end of a machine base, a feeding mechanism and a main chuck assembly are installed at the first slide rail, and an unloading mechanism is installed at the second slide rail; when the pipe is clamped between the feeding mechanism and main chuck assembly for processing by the processing mechanism, the unloading mechanism will move to the bottom of the pipe on the second slide rail to be a support, which enables the processing mechanism to carry out stable processing of pipes, and when the processing is completed, the finished pipes can be unloaded in stable support by the unloading mechanism, which further increases the processing yield of pipes.

### FIELD OF THE INVENTION

The present invention relates to a pipe processing machine, more particularly, a pipe processing machine which can support the pipes and assist in sorting the pipes during processing and unloading.

### BACKGROUND OF THE INVENTION

The conventional pipe processing machine 1 as shown in FIG. 1, is usually equipped with a feeding mechanism 11 on top of a machine frame 10, and a processing mechanism 12 is installed at the end of the machine frame 10, so that the pipe is fixed to the feeding mechanism 11 and then transferred to the processing mechanism 12 for processing. However, to be able to handle the pipes with a certain length, the machine frame 10 needs to reserve at least a length D1 required for feeding the pipes and a length D2 required for processing the pipes, resulting in a large size of the processing machine 1, which takes up a lot of space and causes difficulties in space allocation in the plant. In addition, when the pipe is being processed, the pipe between the feeding mechanism 11 and the processing mechanism 12 is in a suspension status, as a result, it is easy to cause processing defects due to the shaking of the pipe during the pipe conveying process, and after the pipe is processed, the finished products also cannot be stably supported and effectively sorted, so it is obvious that there is a shortcoming to be improved.

For the related prior art, please refer to Taiwan Patent No. 1597119, which discloses “A laser pipe cutting machine with a dust removal mechanism”, a laser tube cutting machine is equipped with a guide rail at the extension of the machine, and a first rotary chuck, a second rotary chuck, and a third rotary chuck are equipped from the right to the left of the guide rail. The first rotary chuck is equipped with a dust removal mechanism adjacent to the first rotary chuck, and the second rotary chuck is equipped with a laser device adjacent to the second rotary chuck, and there is a loading device on the right side of the machine frame, and an unloading device on the left side of the machine frame, whereby the second rotary chuck and the laser device can slide on the guide rail, so that the pipe can be supported during processing.

In addition, Taiwan patent No. M586006 discloses “An improved laser cutting system”, which has a first A-axis processing module and a second A-axis processing module at the two ends of the X-axis processing module, respectively; other than that, a Y-axis processing module and the Z-axis processing module are located next to the second A-axis processing module, and a plural movable clamping module is located next to the X-axis processing module, so that the pipe can be supported by the movable clamping module when the pipe is being processed.

### SUMMARY OF THE INVENTION

Since it is known that pipe processing machine is prone to pipe shaking or defects during pipe conveying, processing and unloading, it is obvious that there are shortcomings that need to be improved.

Therefore, the purpose of the present invention is to provide a movable feeding mechanism, main chuck assembly, processing mechanism and movable unloading mechanism in a machine base, so that the pipe can be supported by the unloading mechanism when conveying, processing and unloading the pipe.

To achieve the foregoing purpose, the present invention provides a pipe processing machine with auxiliary support and sorting structure, comprising: a machine base with a first slide rail and a second slide rail on the front end of the machine base; a feeding mechanism which is movably located on the first slide rail and can be moved on the first slide rail by a power source, and contains a clamping device which can rotate and clamp the pipe; a main chuck assembly which is installed on the machine base, has a perforation and contains a plural clamp around the perforation; a processing mechanism which is installed on the machine base and contains a first movable block, a second movable block movable in the Y-axis direction, a third movable block movable in the Z-axis direction, and a rotary processing head incorporated in the third movable block; and an unloading mechanism movably disposed on a second slide rail, and movable on such second slide driven by the power source; further comprising a first movable plate movable in the X-axis direction, a second movable plate movable in the Y-axis direction, and a placement plate pivoted to the second movable plate.

Based on the above, when the pipe is clamped between the feeding mechanism and the main chuck assembly, the pipe can be conveyed and rotated by the feeding mechanism for the processing machine to process the pipe, and the unloading mechanism can be shifted on the second slide rail to the bottom of the pipe to be a support while processing, so that the processing mechanism can steadily process the pipe; and when the pipe processing is completed, the finished pipe can be unloaded by the unloading mechanism with a stable support status, which further increases the pipe processing yield.

### BRIEF DESCRIPTION OF THE DRAWINGS

FIG. 1 is a schematic diagram of a conventional pipe feeding machine;

FIG. 2 is a perspective view of the pipe processing machine of the present invention;

FIG. 3 is a side view of the pipe processing machine of the present invention;

FIG. 4 is a schematic diagram of the chuck assemble of the present invention;

FIG. 5 is a perspective view of the processing mechanism of the present invention;

FIG. 6 is a schematic diagram of the unloading mechanism of the present invention;

FIG. 7 is a schematic diagram of the pipes feeding of the present invention;

FIGS. 8 to 15 are schematic diagrams of the operation of the pipe processing machine of the present invention;

FIG. 16 is a schematic diagram of the sorting pipes of the unloading mechanism of the present invention;

FIG. 17 is a perspective view of another embodiment of the pipe processing machine of the present invention;

FIG. 18 is a side view of another embodiment of the pipe processing machine of the present invention;

FIG. 19 is another perspective view of another embodiment of the pipe processing machine of the present invention;

FIG. 20 is a perspective view of another embodiment of the processing mechanism of the present invention; and

FIG. 21 is a schematic diagram of the operation of the processing mechanism of another embodiment of the pipe fittings of the present invention.

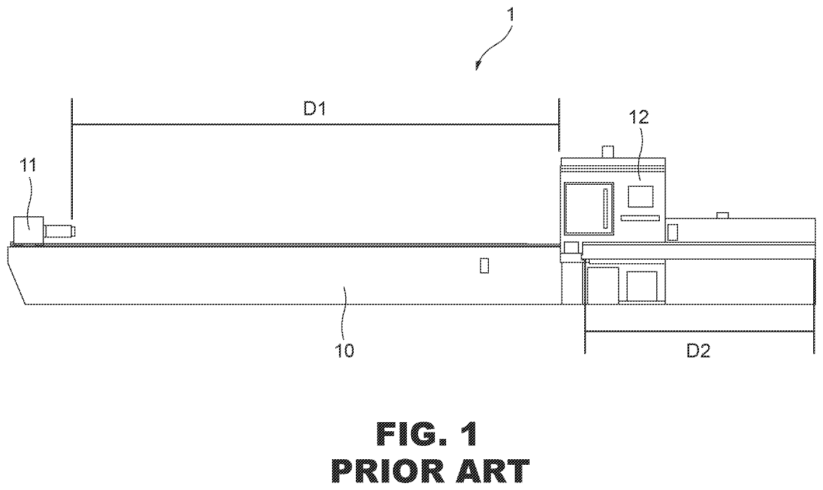

### DESCRIPTION OF THE PREFERRED EMBODIMENTS

In order to achieve a more complete disclosure of the technical contents of the present invention, the following is described in detail, and please also refer to the disclosed drawings and their numbers:

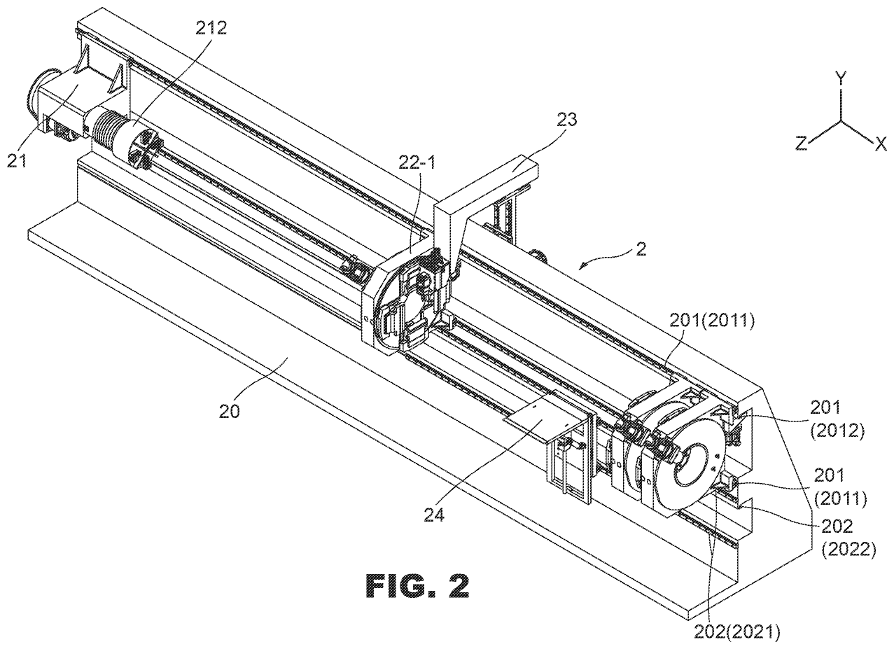

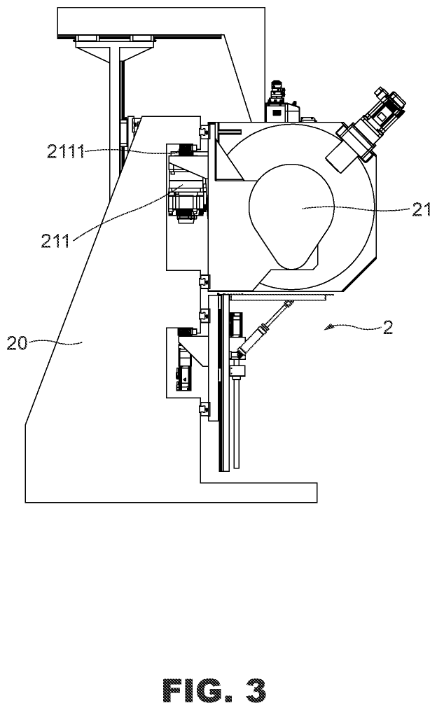

Firstly, please refer to FIGS. 2 to 3. The pipe processing machine 2 of the present invention comprises a machine base 20, a feeding mechanism 21, a main chuck assembly 22-1, a processing mechanism 23 and an unloading mechanism 24. Wherein, a first slide rail 201 and a second slide rail 202 are disposed on the front end of said machine base 20, preferably, the first rail 201 and the second rail 202 both contain two rails 2011, 2021 and one rack 2012, 2022. The feeding mechanism 21 is movable on the first slide rail 201 and can be driven by a power source 211 to move on the two rails 2011, and further contains a clamping device 212 that can rotate and clamp the pipe; preferably, the power source 211 includes a gear 2111 that engages with a rack 2012.

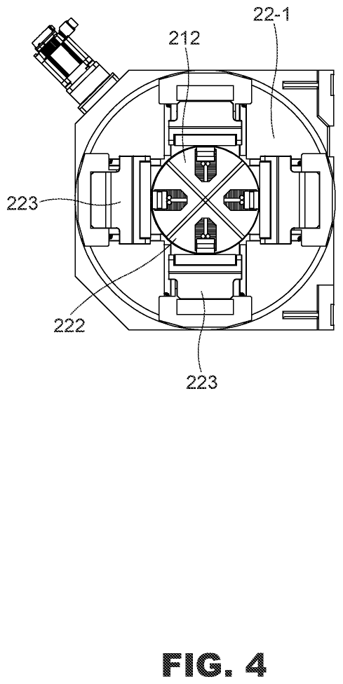

The main chuck assembly 22-1 is located on the first slide rail 201 (refer to FIG. 4), and a perforation 222 is provided in the main chuck assembly 22-1, and plural clamps 223 are installed around the perforation 222; preferably, the perforation 222 has a larger diameter than the outer diameter of the clamping device 212; besides, the clamp 223 of the main chuck assembly 22-1 is a roller clamp.

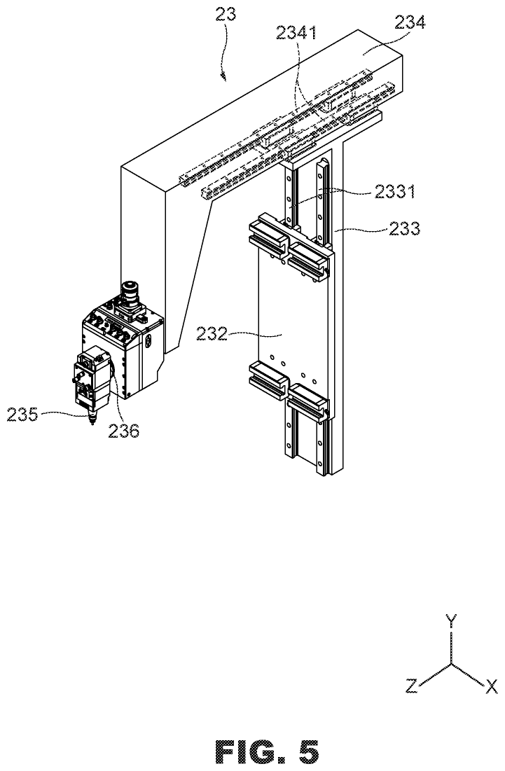

The processing mechanism 23 comprises a first movable block 232, a second movable block 233 movable in the Y-axis direction, a third movable block 234 movable in the Z-axis direction, and a rotary processing head 235 incorporated with the third movable block 234 (refer to FIG. 5). Wherein, the second movable block 233 is T-shaped and has a slide rail 2331 for the first movable block 232 to be embedded in the T-shaped vertical surface, and the third movable block 234 has a slide rail 2341 for the second movable block 233 to be embedded in the T-shaped parallel surface; Preferably, the second movable block 233 and the third movable block 234 can be moved by motor or cylinder drive, and a rotary axis 236 is provided between the third movable block 234 and the rotary processing head 235, so the rotary processing head 235 can oscillate and rotate for processing.

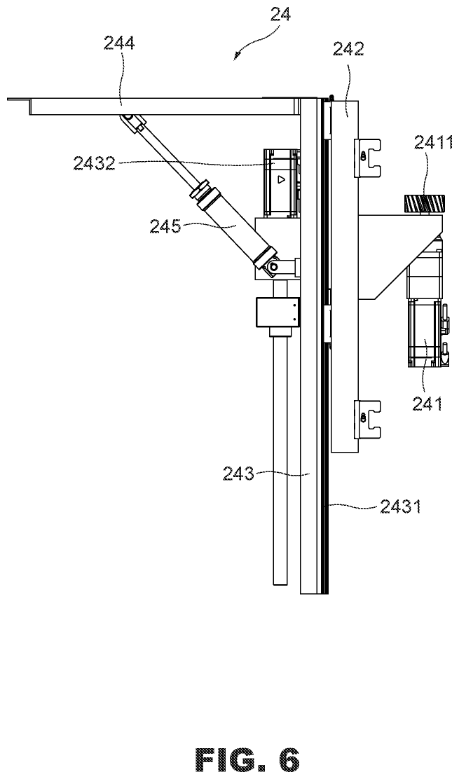

The unloading mechanism 24 is movable on the second slide rail 202 and can be driven by a power source 241 to move on the rial 2010 (refer to FIG. 6), and contains a first movable plate 242 movable in the X-axis direction, a second movable plate 243 movable in the Y-axis direction, and a placement plate 244 pivoted to the second movable plate 243; wherein, the second movable plate 243 is provided with a rail 2431 for the first movable plate 242 to rabbet, and the second movable plate 243 is provided with an adjustable power source 2432 to drive the second movable plate 243 movable in the Y-axis direction. A cylinder 245 is set between the placement plate 244 and second movable plate 243, and the pivot point between the placement plate 244 and the second movable plate 243 can be rotated and tilted at an angle by means of the cylinder 245, preferably, the power source 241 contains a gear 2411 that engages with a rack 2022.

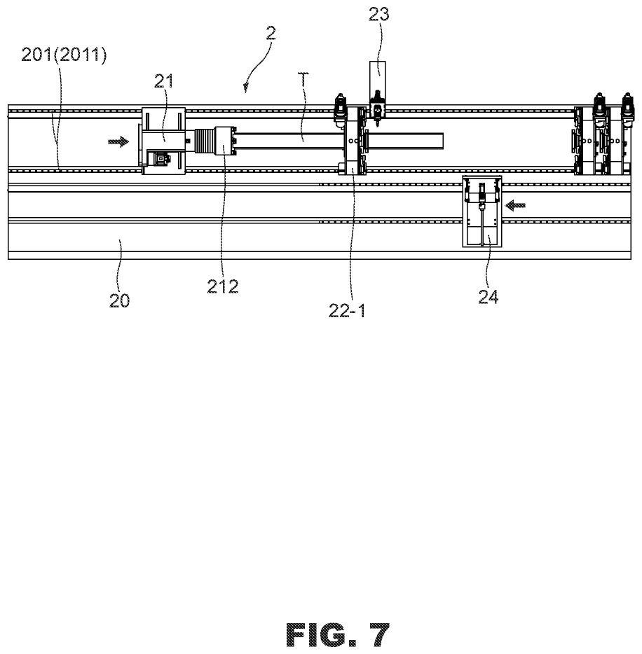

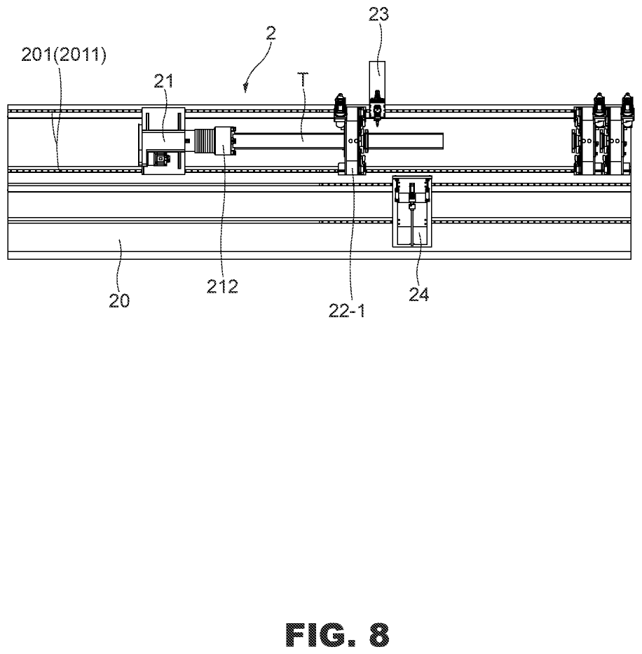

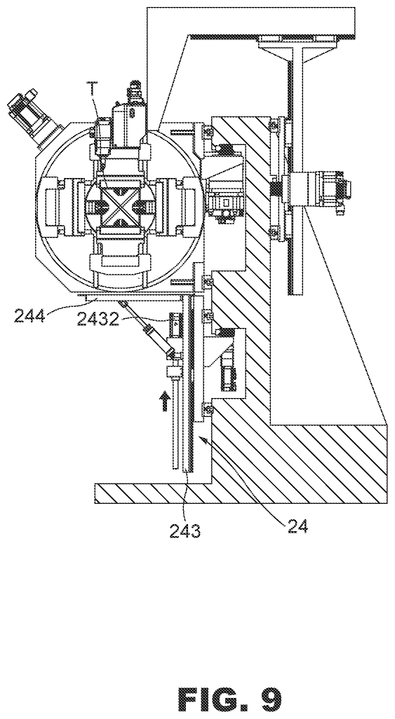

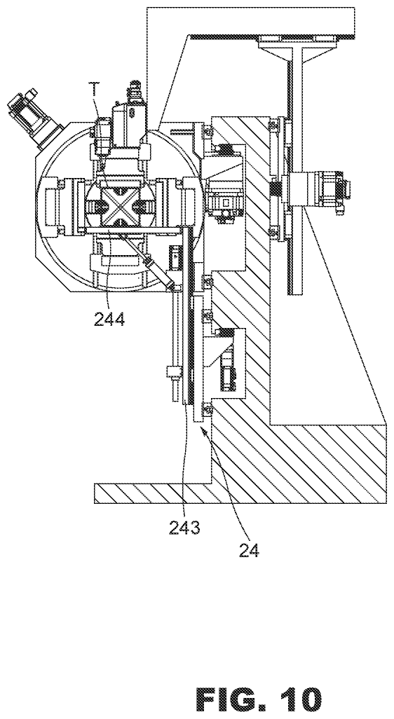

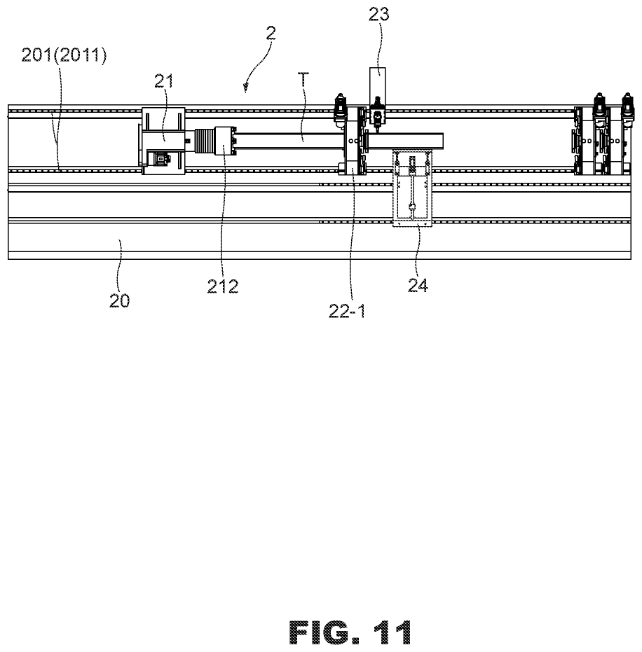

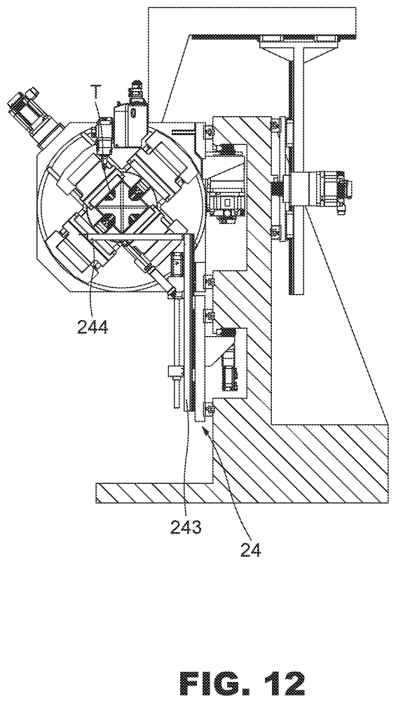

Secondly, please refer to FIGS. 2 to 6 in association with FIG. 7, when the pipe processing machine 2 of the present invention is feeding, the pipe T is fixed in the clamping device 212, and driving the feeding mechanism 21 to move on the two rails 2011 through the power source 211, in cooperation with the pipe which is supported by the main chuck assembly 22-1, then drive the unloading mechanism 24 to move on the two rails 2021 of the second slide rail 202 to the end of the pipe T to be processed (as shown in FIG. 8), and drive the second movable plate 243 upwardly by adjusting the power source 2432 until the placement plate 244 touches with the bottom of the pipe T (as shown in FIGS. 9 and 10), to further provide a support to the pipe T by means of placement plate 244 of the unloading mechanism 24 (as shown in FIG. 11) to facilitate the processing of the pipe T by the processing mechanism 23. In addition, since the processing of the pipe T may result in a rotation (as shown in FIG. 12), then the unloading mechanism 24 can be used to adjust the height of the second movable plate 243 to timely provide a support to the pipe T.

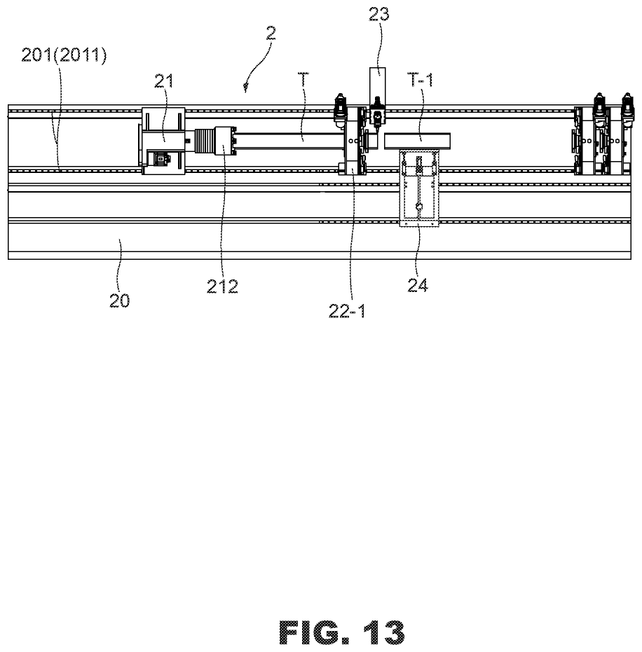

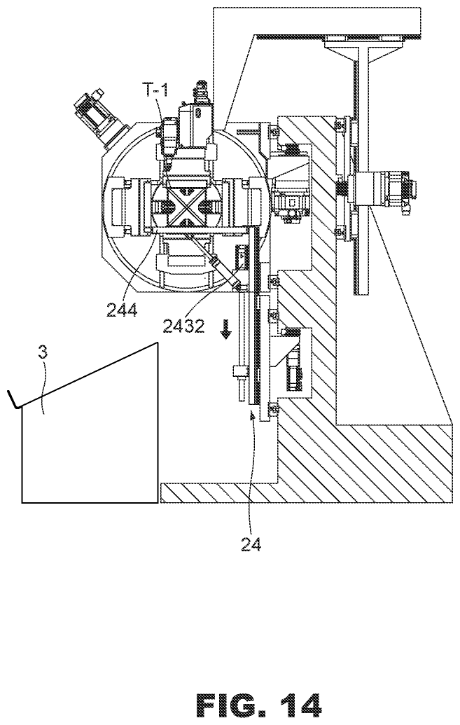

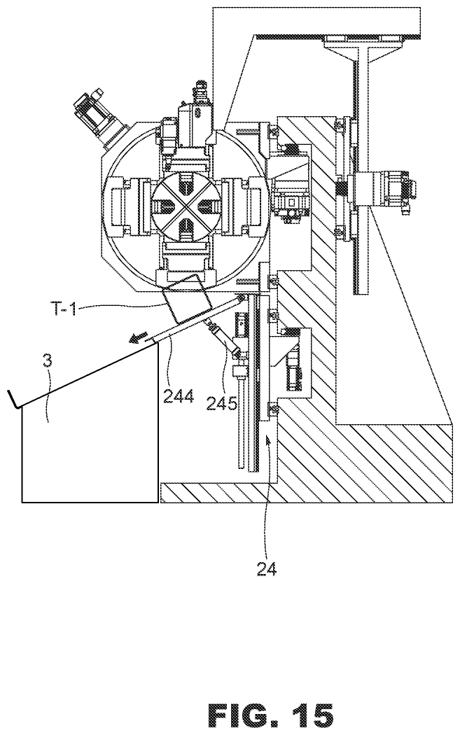

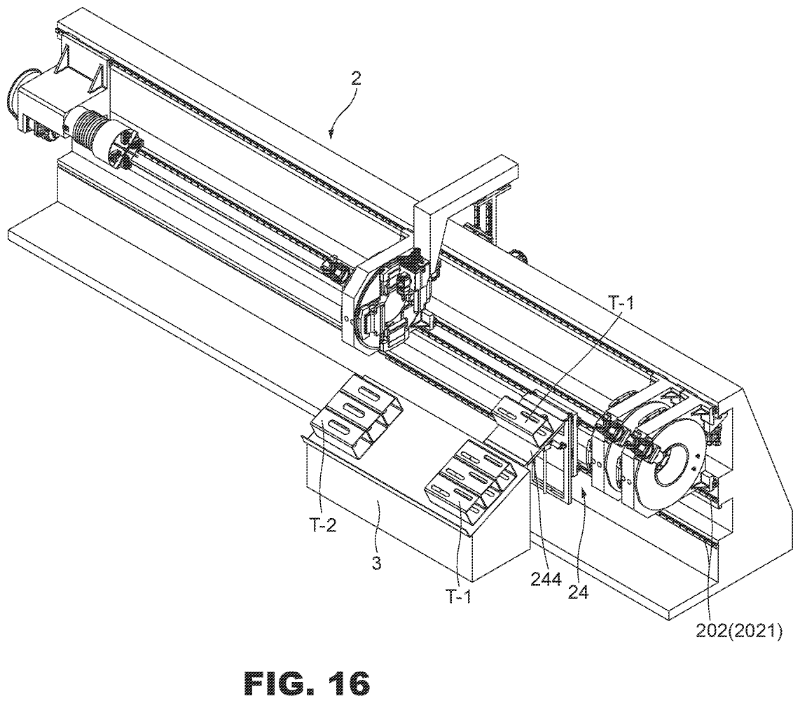

When pipe T is finished cutting or processing, please refer to FIG. 13, the finished cut pipe T-1 is placed directly on top of the placement plate 244 of the unloading mechanism 24, therefore, it is suitable to provide a hopper 3 in front of the pipe processing machine 2. Please refer to FIG. 14, the finished cut pipe T-1 which places on the placement plate 244, it can drive the second movable plate 243 to move that placement plate 244 and pipe T-1 downwardly to an appropriate position by adjusting the power source 2432, and drive the placement plate 244 directly tilt towards the hopper 3 through the cylinder 245 of the unloading mechanism 24 (as shown in FIG. 15), thereafter the pipe T-1 slides directly along the placement plate 244 to the hopper 3 then complete unloading of the pipe T-1 automatically. In addition, the pipe processing machine 2 can use the unloading mechanism 24, which is movable on the second slide rail 202, to assist in moving the pipes T-1 and T-2 for different processing operations (as shown in FIG. 16), so the pipes T-1 and T-2 can complete quickly and simultaneously the unloading and sorting operations by the tiltable placement plate 244 of the unloading mechanism 24.

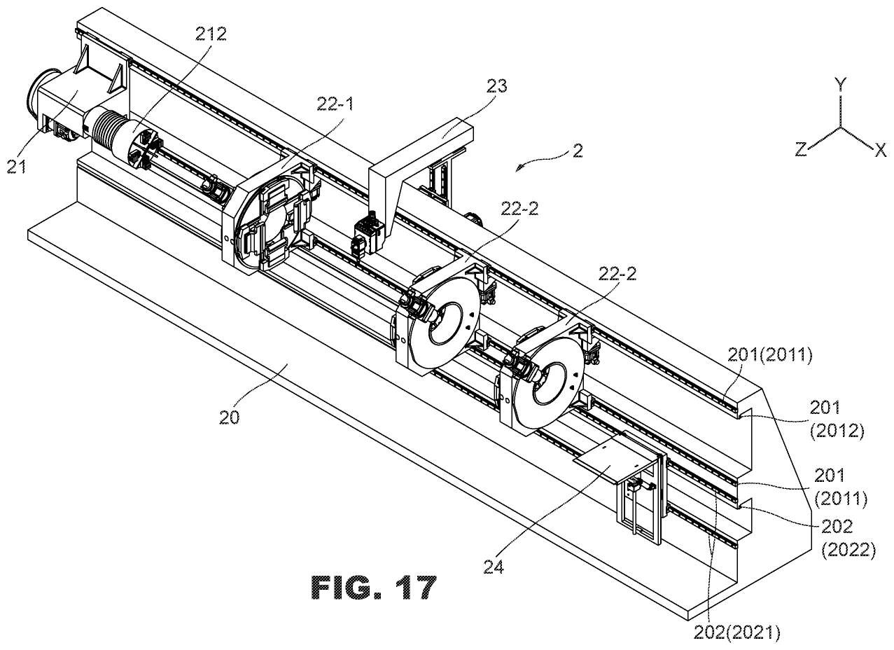

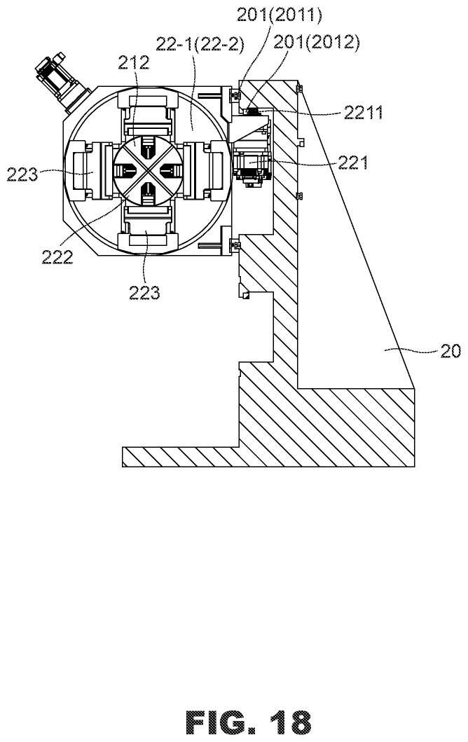

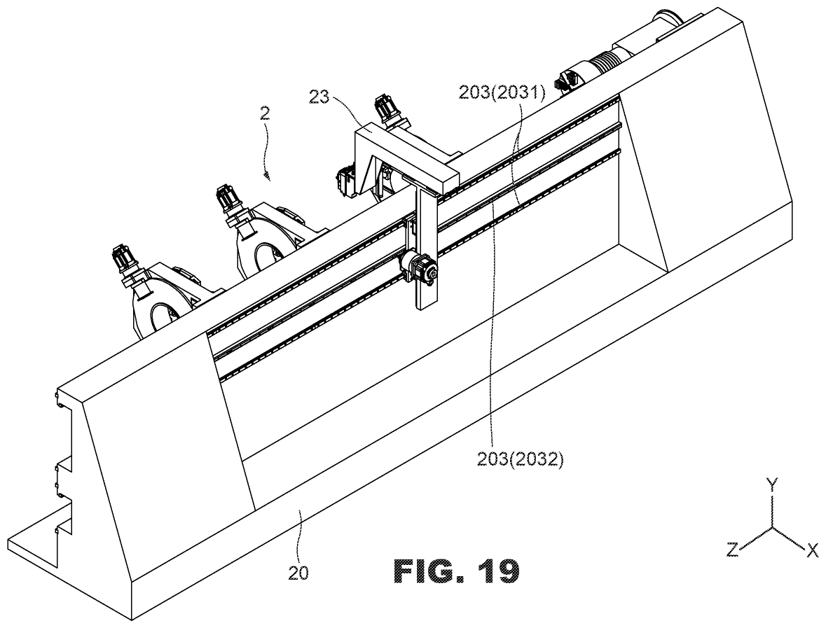

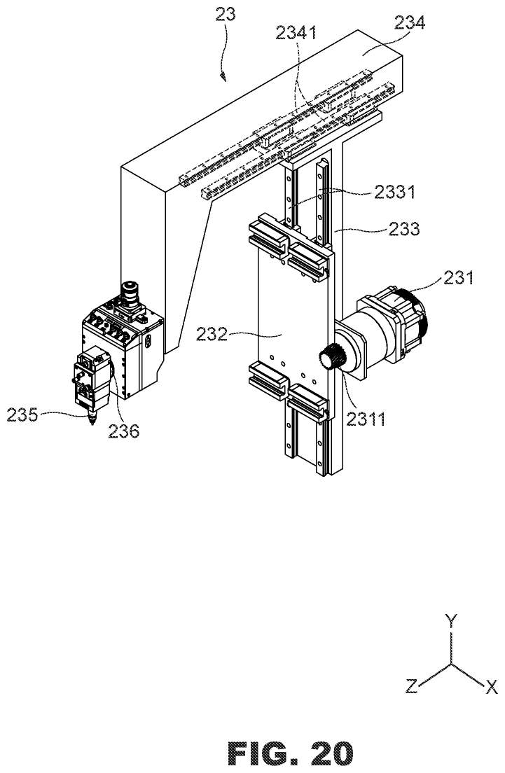

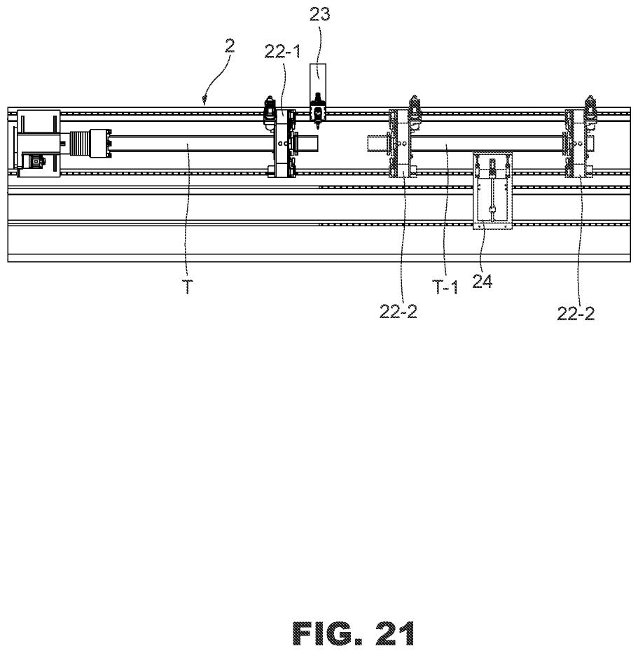

Please refer to FIG. 17, in another embodiment of the present invention, it is possible to provide a desired number of additional sub-chuck assembly 22-2 as required, and to make the main chuck assembly 22-1 and the sub-chuck assembly 22-2 movable on the first slide rail 201 (see FIG. 18), and can be driven by the power source 221 to move on the two rails 2011 of the first slide rail 201. In addition, at the rear end of the machine base 20 installed a third slide rail 203 containing two rails 2031 and a rack 2032 (as shown in FIG. 19), this lets the first movable block 232 of the processing mechanism 23, which can move in the X-axis direction, movably installed on the third slide rail 203, and it also can be driven to move on the rail 2031 of the third slide rail 203 through the power source 231 (as shown in FIG. 20), preferably, the power source 231 includes a gear 2311 that engages with a rack 2032. With the above movable main chuck assembly 22-1, sub-chuck assembly 22-2, processing mechanism 23 and unloading mechanism 24 (as shown in FIG. 21), the pipe processing machine 2 can flexibly shift and support pipe T with the operations of pipe T feeding, processing and unloading to increase the usability of the pipe processing machine.

Therefore, it is obvious that the use of the pipe processing machine of the present invention can achieve the following effects:
1. the pipe processing machine of this invention is equipped with the movable unloading mechanism to control the displacement and elevation of the unloading mechanism, so that the pipe is stably supported during the processing and the finished pipe is unloaded under stable support as well, to improve the yield of pipe processing;
2. the front of the unloading mechanism of the present invention can be equipped with the hopper, the placement plate can be driven by adjusting the power source to move to tilt towards the hopper, and then slide the finished pipe on the placement plate to the hopper in an automatic manner to improve the efficiency of pipe processing;
3. the unloading mechanism of this invention can be shifted on the slide rail of the machine base, so that the finished pipe on the placement plate can be directly shifted to the corresponding sorting position of the hopper, and then the placement plate can be tilted to unload the pipe, so that the unloading and sorting operation of the pipe can be completed quickly; and
4. the pipe processing machine of the present invention can be flexibly shifted and support the pipe with the operations of feeding, processing and unloading, through the movable main chuck assembly, sub-chuck assembly, processing mechanism and unloading mechanism, which can increase the practicality of the pipe processing machine.

While the present invention has been described by means of specific embodiments, numerous modifications and variations could be made thereto by those skilled in the art without departing from the scope and spirit of the present invention set forth in the claims.

What is claimed is:

1. A pipe processing machine with auxiliary support and sorting structure, comprising:
a machine base, having a first slide rail and a second slide rail set on the front end of the machine base;
a feeding mechanism, movable on the first slide rail and is able to move on the first slide rail driven by a power source, and comprising a clamping device for rotating and clamping the pipe;
a main chuck assembly, being provided on the machine base, the main chuck assembly having a perforation, and containing plural clamps surrounding the perforation;
a processing mechanism, being disposed on the machine base, and comprising a first movable block, a second movable block movable in the Y-axis direction, a third movable block movable in the Z-axis direction, and a rotary processing head incorporated in the third movable block; and
an unloading mechanism, being movably disposed on the second slide rail and is able to move on the second slide rail driven by a power source, and comprising a first movable plate movable in the X-axis direction, a second movable plate movable in the Y-axis direction, and a placement plate pivoted to the second movable plate.

2. The pipe processing machine with auxiliary support and sorting structure according to claim 1, wherein a cylinder is installed between the placement plate and the second movable plate, and the pivot point between the placement plate and second movable plate can be rotated and tilted at an angle by means of the cylinder.

3. The pipe processing machine with auxiliary support and sorting structure according to claim 1, wherein the second movable plate is provided with a rail for the first movable plate to rabbet, and the second movable plate is provided with an adjustable power source to drive the second movable plate movable in the Y-axis direction.

4. The pipe processing machine with auxiliary support and sorting structure according to claim 1, wherein the main chuck assembly is movable on the first slide rail and can be moved on the first slide rail driven by a power source comprising a gear engaged with a rack of the first slide rail.

5. The pipe processing machine with auxiliary support and sorting structure according to claim 1, wherein the first slide rail and the second slide rail both contain two rails and a rack, and the power source contains a gear engaged with a rack.

6. The pipe processing machine with auxiliary support and sorting structure according to claim 1, wherein a third slide rail is provided at the rear end of the machine base, so that the processing mechanism can be movably disposed on the third slide rail and can be moved on the third slide rail driven by the power source.

7. The pipe processing machine with auxiliary support and sorting structure according to claim 1, wherein the third rail set comprises two rails and a rack, and the power source comprises a gear engaged with a rack.

8. The pipe processing machine with auxiliary support and sorting structure according to claim 1, wherein the diameter of the perforation is larger than the outer diameter of the clamping device.

9. The pipe processing machine with auxiliary support and sorting structure according to claim 1, wherein the first movable block is movable in the X-axis direction, the second movable block is T-shaped and has a slide rail for the first movable block to be embedded in the T-shaped vertical surface, and the third movable block has a slide rail for the second movable block to be embedded in the T-shaped parallel surface, and the second movable block and the third movable block are movable by means of a motor or a cylinder.

10. The pipe processing machine with auxiliary support and sorting structure according to claim 1, wherein a rotary axis is provided between the third movable block and the rotary processing head to enable the rotary processing head to oscillate and rotary for processing.
